(19) United States
(12) Patent Application Publication
(10) Pub. No.: US 2024/0408933 A1
(43) Pub. Date: Dec. 12, 2024

(54) OVERHEAD AMBIENT AIR CONTROL SYSTEMS

(71) Applicant: EMBRAER S.A., São José dos Campos – SP (BR)

(72) Inventors: Samantha Gonzalez TESSELE, São José dos Campos – SP (BR); Jay BEEVER, São José dos Campos – SP (BR); Bruno Kimura CASTANHA, São José dos Campos – SP (BR); Silvio Hideo Lemos MOCHIDUKY, São José dos Campos – SP (BR); Hugo MOTOYAMA, São José dos Campos – SP (BR); Victor Hugo de Oliveira COTRIM, São José dos Campos – SP (BR); Erik Vasconcelos DA SILVA, São José dos Campos – SP (BR); Patricia Greff DE LIMA, São José dos Campos – SP (BR); Alan Felipe Castilho MAIA, São José dos Campos – SP (BR); Joshua REA, São José dos Campos – SP (BR); Divanir Fernando Neves Fernandes GONÇALVES PIRES, São José dos Campos – SP (BR); Beenal DESAI, São José dos Campos – SP (BR); Thais BORTHOLIN, São José dos Campos – SP (BR); Ramon PAPA, São José dos Campos – SP (BR); Patricia Silva Madeira CHAGAS, São José dos Campos – SP (BR)

(21) Appl. No.: 18/417,788

(22) Filed: Jan. 19, 2024

Related U.S. Application Data
(60) Provisional application No. 63/506,940, filed on Jun. 8, 2023.

(51) Int. Cl. B60H 1/00; B61D 27/00; B64D 13/00; B64D 13/02

(52) U.S. Cl. CPC B60H 1/00028; B60H 1/00457; B61D 27/009; B64D 13/02; B60H 2001/00235; B64D 2013/003

(57) ABSTRACT

Overhead passenger comfort modules are provided with a module segment having a support frame member which includes a perimetrical trim frame member, and a ventilation system supported by the support frame member. The ventilation system includes a supply conduit adapted to being fluid-connected to a supply of ventilation air, and first and second branch conduits fluid-connected at one end to the supply conduit and terminating in elongate first and second ventilation openings at first and second edge regions of the support frame member. First and second concavely curved edge diffuser portions are provided which are adjacently positioned to and spaced from the first and second ventilation openings respectively. Ventilation air discharged from the first and second ventilation openings will therefore impinge on the concavely curved first and second edge diffuser portions so as create a diffused volume of air which envelops substantially a passenger seated therebelow and establish a personal ambient air zone for the passenger.

### CROSS-REFERENCE TO RELATED APPLICATION

This application is based on and claims domestic priority benefits from U.S. Provisional Application Ser. No. 63/506,940 filed on Jun. 8, 2023, the entire content of which is expressly incorporated hereinto by reference.

### FIELD

The embodiments disclosed herein relate generally to overhead ambient air control systems that are provided for the comfort of vehicle passengers, for examples, passengers being transported by mass transit vehicles such as aircraft, buses, trains and the like.

### BACKGROUND

It is conventional in many mass transit vehicles, such as aircraft, to have an overhead passenger comfort module that may include personal lights and forced air ventilation devices. The forced air ventilation devices are typically poppet valves that the passenger can screw/unscrew which in turn causes the poppet of the valve to close/open relative to a vent opening and thereby regulate the amount of air ventilation being delivered. The air flow direction can also be manipulated by providing a ball and socket connection of the poppet valve to the overhead passenger comfort module. These types of conventional forced air ventilation devices are colloquially known as “gaspers” in aircraft parlance.

One problem associated with conventional gaspers is that the devices cannot typically be employed for long periods of time during transport due to the rather narrow jet of ventilation air that is discharged which can cause passenger discomfort during prolonged use. For example, if the rather narrow jet of ventilation air is directed towards the passenger's face, a feeling dryness in the passenger's eyes and nose may occur. The passenger may then redirect the jet of ventilation air to different areas of the face or even close the gasper completely after short periods of use. The conventional gaspers are also not conducive to the aesthetics of modern executive transport cabins.

What has been needed in this art therefore are forced air ventilation devices that reduce or eliminate entirely the problems associated with conventional gasper devices. It is towards providing a solution to such a problems that the embodiments disclosed herein are directed.

### SUMMARY

Broadly, the embodiments disclosed herein are directed toward personal overhead air ventilation devices for vehicle passengers that distribute the air flow between two possible output paths into a concave frame that diffuses and widely disperses the air flow thereby generating a personalized ambient air zone establishing a personal microclimate for the passenger. Further, the existence of two air outlet paths having their respective openings electronically controlled allows for different air flow intensity and greater air flow coverage for the ambient air zone. The ambient air zone will thereby in turn create a personalized atmosphere for the vehicle passenger that, when used for long periods of time, is more comfortable (e.g., less noisy, does not dry the passenger's eyes/nose and the like).

According to the embodiments disclosed herein, air ventilation devices are included in an overhead passenger comfort module and are responsible for providing air to passengers through one or both of the two electronically controlled outlets. The air ventilation device receives air from the on-board air conditioning or outside air ventilation distribution system and directs the air through vents into the cabin and into the passenger comfort module located above each passenger. As soon as the air leaves the supply tubes of the air supply system, it freely impinges on a concavely curved profiled edge frame that causes the air to lose velocity and gain dispersion in the flow area thereby creating a kind of “mist” close to the passenger's face. This mist of diffused air provides freshness (e.g., ambient air effect) without the need to have an air jet being directed onto the passenger's body and causing discomfort due to high air flow velocity typically associated with conventional gasper devices.

According to certain embodiments an overhead passenger comfort module is provided which includes a module segment comprising a support frame member which includes a perimetrical trim frame member, and a ventilation system supported by the support frame member. The ventilation system may preferably include a supply conduit adapted to being fluid-connected to a supply of ventilation air, and first and second branch conduits fluid-connected at one end to the supply conduit and terminating in elongate first and second ventilation openings at first and second edge regions of the support frame member. The trim frame member may itself include first and second concavely curved first and second edge diffuser portions which are adjacently positioned to and spaced from the first and second ventilation openings respectively. Ventilation air discharged from the first and second ventilation openings will therefore impinge on the concavely curved first and second edge diffuser portions of the trim frame member so as create a diffused volume of air which envelops substantially a passenger seated therebelow to establish a personal ambient air zone for the passenger.

The overhead passenger comfort module according to some embodiments may include first and second valves operatively associated with the first and second branch conduits and operable to control air flow therethrough, respectively. A passenger accessible control unit may thus be operably connected to the first and second valves to allow passenger control of the air flow through the first and second branch conduits, respectively, thereby adjusting the ambient air zone to suit personal preferences.

The support frame may include a front face plate attached thereto so as to visibly cover the ventilation system supported by the support frame. The front face plate may be substantially planar.

In some embodiments, the first and second ventilation openings are positioned at side and bottom edge regions of the support frame member. The concavely curved first and second edge diffuser portions will thereby be adjacently positioned to and spaced from the first and second ventilation openings at the side and bottom edge regions of the support frame member, respectively.

A mirror image pair of the module segments may be provided. Such an embodiment is especially useful for overhead passenger comfort for vehicles having so-called club seating arrangements (i.e., a pair of facing passenger seats). In such an embodiment, each of the module segments can be positioned overhead of a respective one of the passenger seats so as to provide the passengers in the seats with a respective individualized ambient air zone.

These and other aspects and advantages of the present invention will become clearer after careful consideration is given to the following detailed description of the preferred exemplary embodiments thereof.

### BRIEF DESCRIPTION OF ACCOMPANYING DRAWINGS

The disclosed embodiments of the present invention will be better and more completely understood by referring to the following detailed description of exemplary non-limiting illustrative embodiments in conjunction with the drawings of which:

FIGS. 1A and 1B are elevational view of an aircraft cabin interior showing the placement of overhead passenger comfort modules in a club seating arrangement which include a conventional air gasper (FIG. 1A) and an air ventilation system in accordance with an embodiment of the present invention (FIG. 1B);

FIGS. 2 and 3 are respectively isolated bottom from and top front perspective views of the air ventilation system shown in FIG. 1B according to an embodiment of the present invention;

FIG. 4 is a back side plan view of the air ventilation system shown in FIGS. 2 and 3;

FIG. 5 is an enlarged perspective view of an end portion of the air ventilation system shown in FIGS. 2 and 3;

FIG. 6 is a cross-sectional view of the air ventilation system as taken along lines 6-6 in FIG. 5; and

FIG. 7 is a cross-sectional view of the air ventilation system as taken along lines 7-7 in FIG. 5.

### DETAILED DESCRIPTION OF EMBODIMENTS

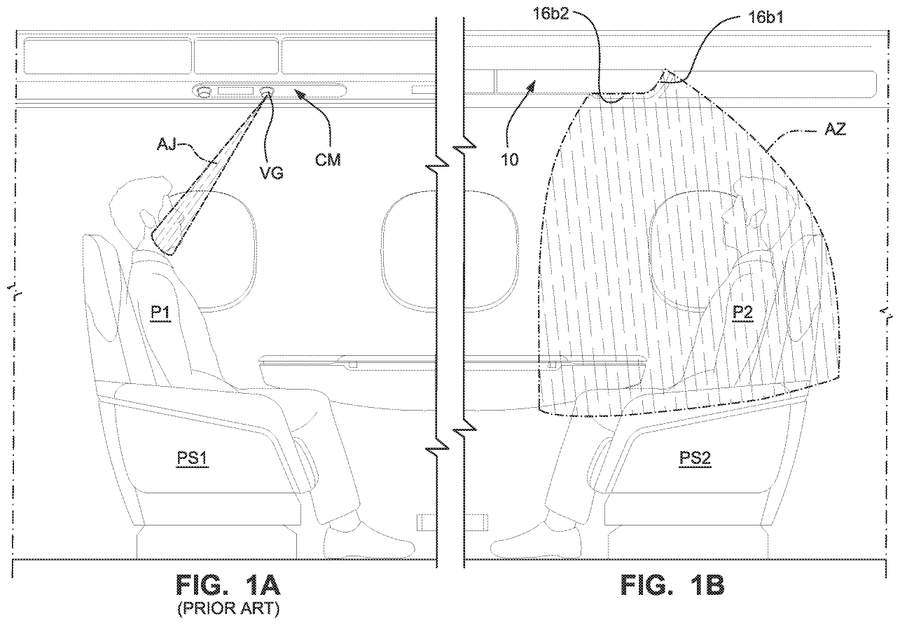

Accompanying FIG. 1A schematically illustrates and interior space of a vehicle, e.g., an interior cabin of an aircraft, provided with a conventional overhead passenger comfort module CM that includes a ventilation gasper VG. A passenger seat PS1 is positioned in proximity below the comfort module CM so that a relatively narrow air jet AJ issuing from the gasper VG can be directed toward the face of a passenger P1 in a seated in the passenger seat PS1. As noted briefly above, the gasper VG can be manipulated so as to open/close associated poppet valve to regulate the amount of air flow in the air jet and/or swivel the gasper VJ to select the desired directional vector for the air jet AJ.

The overhead passenger comfort module 10 in accordance with an embodiment of the present invention is depicted in FIG. 1B. Rather than the relatively narrow air jet AJ created by the conventional gasper VG, the passenger comfort module 10 creates a widely diffused air zone AZ which envelops the passenger P2 seated in the passenger seat PS2 therebelow. As such, the passenger conform module 10 in accordance with the embodiments of the present invention provides the passenger P2 with a personal ambient air environment that can be modulated and controlled as will be described below.

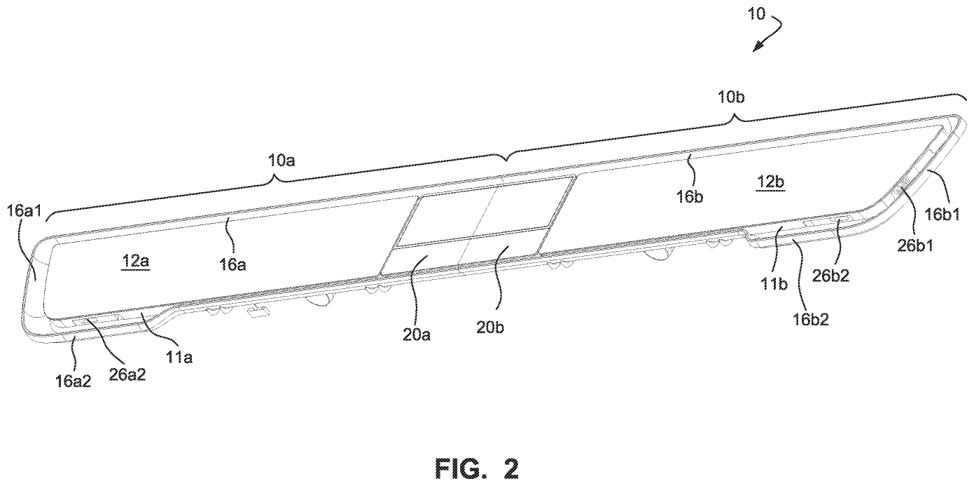

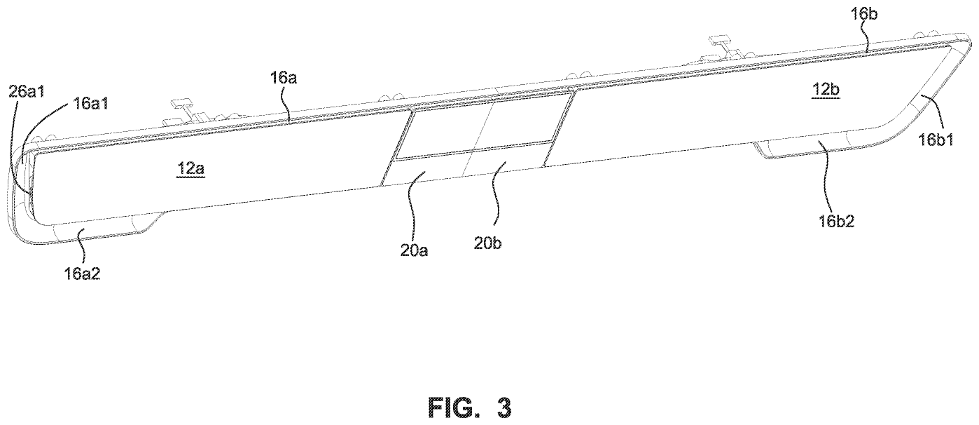

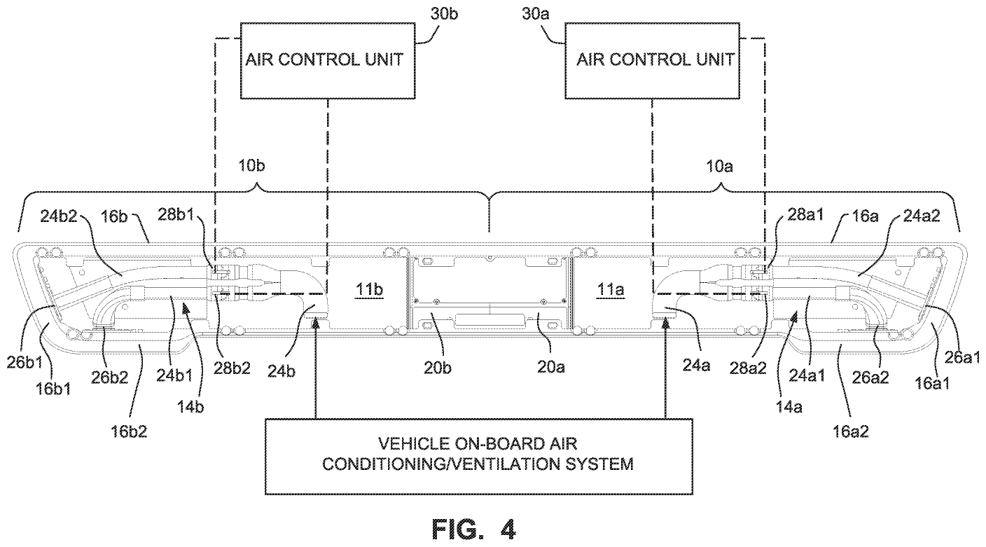

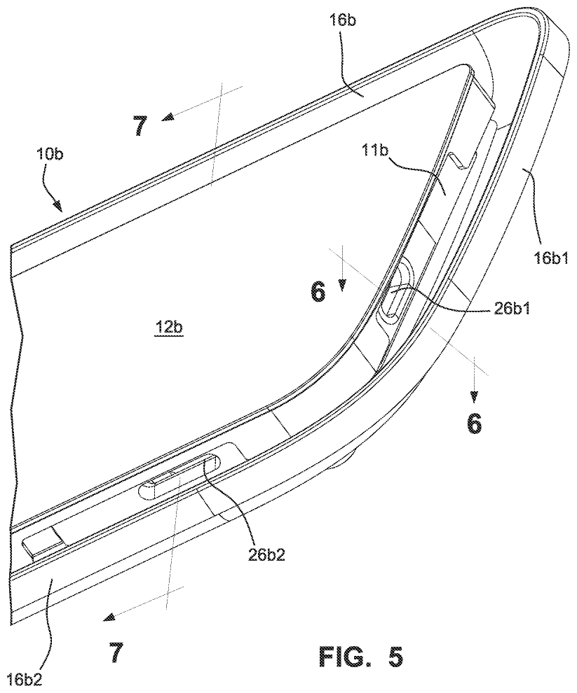

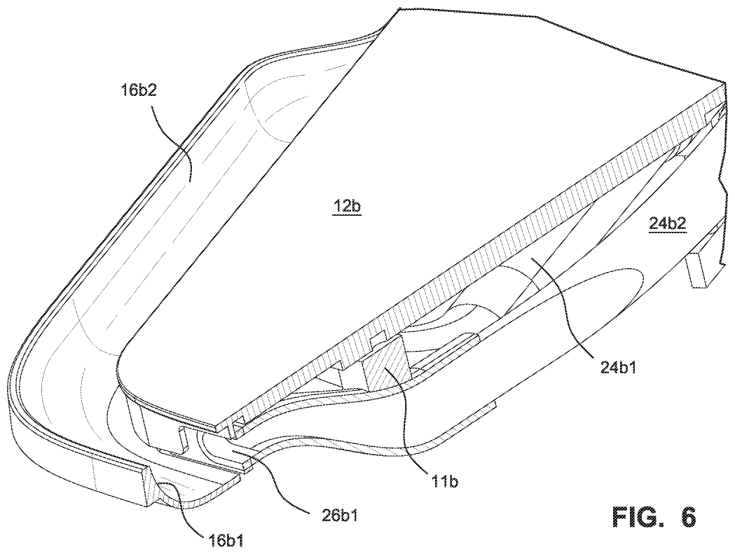

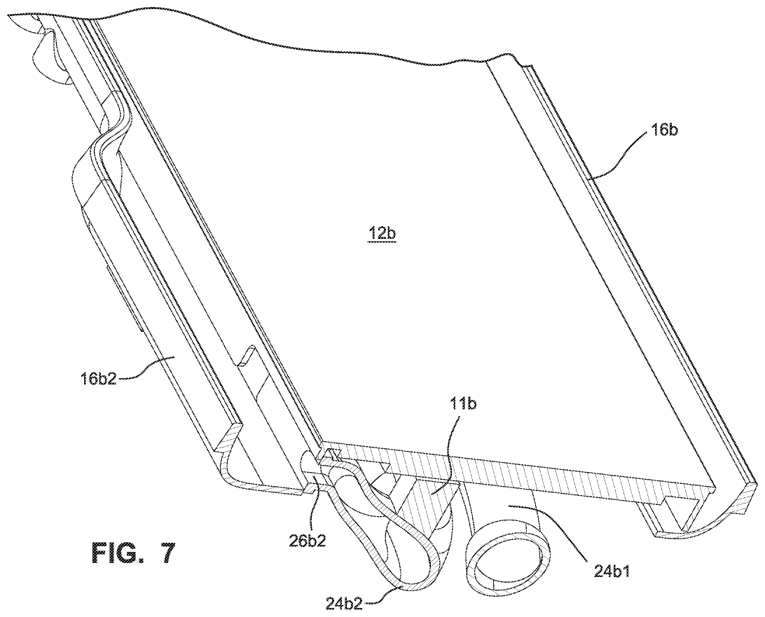

Accompanying FIGS. 2-7 show the passenger comfort module 10 in accordance with an embodiment of the present invention in greater detail. As shown therein, the passenger comfort module 10 is provided with mirror image module segments 10a, 10b each respectively having a support frame 11a, 11b and a visible substantially planar front faceplate 12a, 12b which covers the support frame 11a, 11b and the ventilation system 14a, 14b supported by the support frame 11a, 11b (see FIG. 4). A trim frame member 16a, 16b is integrally joined to the support frame members 11a, 11b and surrounds the perimetrical edge of the faceplate 12a, 12b. Each of the trim frame members 16a, 16b integrally includes concavely curved side edge diffuser and bottom edge diffuser portions 16a1, 16a2, 16b1, 16b-2 that are adjacent to and spaced from the side and the distal bottom edges of the faceplate 12a, 12b, respectively.

Optionally, each of the module segments 10a, 10b may be provided with an annunciator light system 20a, 20b. Alternatively, the annunciator light system 20a, 20b can be substituted with an informational display screen if desired or some other form of passenger interface device.

Important to the embodiments disclosed herein, the ventilation systems 14a, 14b of the module segments 10a, 10b will include a supply conduit 24a, 24b connected to the on-board air conditioning/ventilation system 25 of the vehicle. Each of the supply conduits are fluid connected to a pair of branch conduits 24a1, 24a2 and 24b1, 24b2 that terminate in respective elongate ventilation openings 26a1, 26a2, 26b1, 26b2. The air flow volume and hence velocity through each of the branch conduits 24a1, 24a2 and 24b1, 24b2 is controlled through individual electrically operated valves 28a1, 28a2, 28b1, 28b2 that can be controlled by the passenger P2 via air control units 30a, 30b, respectively. The air control units 30a, 30b can be an integral component of the module segments 10a, 10b or mounted in proximity to or as a component part of the passenger seat.

It will be appreciated that the passenger comfort module 10 depicted in drawing FIGS. 2-7 and described hereinabove may be used satisfactorily in a club seating arrangement as depicted in FIG. 1 where each of the passengers P1, P2 may enjoy the diffused ambient air environment that is achieved by the respective module segments 10a, 10b, respectively. Of course, those skilled in this art will realize that the embodiments disclosed herein may be used for other types of seating arrangements, including in-line seating arrangements.

The air jets discharged from each of the elongate ventilation openings 26a1, 26a2, 26b1, 26b2 will therefore impinge on the concavely curved side edge diffuser and bottom edge diffuser portions 16a1, 16a2, 16b1, 16b-2, respectively. Specifically, the air jets discharged from the ventilation openings 26a1, 26b1 will be directed toward the curved side edge diffuser portions 16a1, 16b1 in a direction generally parallel or slightly angled downwardly (e.g.,) 5°-15° relative to the longitudinal axis of the module segments 10a, 10b, respectively. On the other hand, the air jets discharged from the ventilation openings 26a2, 26b2 will be directed toward the curved side edge diffuser portions 16a2, 16b2 in a direction that is substantially normal (e.g., 90°±about 5°. Thus, the air jets discharged from the ventilation openings 26b1, 26b2 which impinge on the side and bottom edge diffusers 16b1, 16b2 will be caused to merge thereby forming the widely diffused air zone AZ volume which envelops the passenger P2 seated in the passenger seat PS2 therebelow (see FIG. 1B). Similarly, although not shown, if the passenger seat PS1 were to be provided with the module unit 10a rather than the conventional comfort module that includes the ventilation gasper VG as shown in FIG. 1A, then the air jets discharged from the ventilation openings 26a1, 26a2 which impinge on the side and bottom edge diffusers 16a1, 16a2 will be caused to merge thereby forming a similar widely diffused air zone volume which envelops the passenger P1 seated in the passenger seat PS1 therebelow.

Therefore, while reference is made to particular embodiments of the invention, various modifications within the skill of those in the art may be envisioned. Therefore, it is to be understood that the invention is not to be limited to the disclosed embodiment, but on the contrary, is intended to cover various modifications and equivalent arrangements included within the spirit and scope thereof.

What is claimed is:

1. An overhead passenger comfort module which includes a module segment comprising:
a support frame member which includes a perimetrical trim frame member; and
a ventilation system supported by the support frame member, wherein
the ventilation system comprises:
(i) a supply conduit adapted to being fluid-connected to a supply of ventilation air; and
(ii) first and second branch conduits fluid-connected at one end to the supply conduit and terminating in elongate first and second ventilation openings at first and second edge regions of the support frame member, and wherein
the trim frame member includes first and second concavely curved edge diffuser portions which are adjacently positioned to and spaced from the first and second ventilation openings respectively, wherein
ventilation air discharged from the first and second ventilation openings impinges on the concavely curved first and second edge diffuser portions of the trim frame member so as create a diffused volume of air which envelops substantially a passenger seated therebelow to establish a personal ambient air zone for the passenger.

2. The overhead passenger comfort module according to claim 1, which further comprises first and second valves operatively associated with the first and second branch conduits and operable to control air flow therethrough, respectively.

3. The overhead passenger comfort module according to claim 2, which further comprises a control unit operably connected to the first and second valves to allow passenger control of the air flow through the first and second branch conduits, respectively.

4. The overhead passenger comfort module according to claim 1, further comprising a front face plate attached to the support frame and visibly covering the ventilation system.

5. The overhead passenger comfort module according to claim 4, wherein the front face plate is substantially planar.

6. The overhead passenger comfort module according to claim 1, wherein
the first and second ventilation openings are positioned at side and bottom edge regions of the support frame member, and wherein
the concavely curved first and second edge diffuser portions are adjacently positioned to and spaced from the first and second ventilation openings at the side and bottom edge regions of the support frame member, respectively.

7. The overhead passenger comfort module according to claim 1, further comprising at lease one of a speaker system, annunciator light system and information display screen.

8. A vehicle which comprises a passenger seat and the overhead passenger comfort module according to claim 1 positioned over the passenger seat.

9. The vehicle according to claim 9, wherein the vehicle is a passenger aircraft, a passenger bus or a passenger train car.

10. An overhead passenger comfort module which includes a mirror image pair of adjacent module segments, wherein each of the module segments comprises:
a support frame member which includes a perimetrical trim frame member; and
a ventilation system supported by the support frame member, wherein
the ventilation system comprises:
(i) a supply conduit adapted to being fluid-connected to a supply of ventilation air; and
(ii) first and second branch conduits fluid-connected at one end to the supply conduit and terminating in elongate first and second ventilation openings at first and second edge regions of the support frame member, and wherein
the trim frame member includes first and second concavely curved edge diffuser portions which are adjacently positioned to and spaced from the first and second ventilation openings respectively, wherein
ventilation air discharged from the first and second ventilation openings impinges on the concavely curved first and second edge diffuser portions of the trim frame member so as create a diffused volume of air which envelops substantially a passenger seated therebelow to establish a personal ambient air zone for the passenger.

11. The overhead passenger comfort module according to claim 10, which each of the module segments further comprises first and second valves operatively associated with the first and second branch conduits and operable to control air flow therethrough, respectively.

12. The overhead passenger comfort module according to claim 11, wherein each of the module segments further comprises a control unit operably connected to the first and second valves to allow passenger control of the air flow through the first and second branch conduits, respectively.

13. The overhead passenger comfort module according to claim 10, wherein each of the module segments further comprises a front face plate attached to the support frame and visibly covering the ventilation system.

14. The overhead passenger comfort module according to claim 13, wherein the front face plate is substantially planar.

15. The overhead passenger comfort module according to claim 10, wherein
the first and second ventilation openings are positioned at side and bottom edge regions of the respective support frame member, and wherein
the concavely curved first and second edge diffuser portions are adjacently positioned to and spaced from the first and second ventilation openings at the side and bottom edge regions of the support frame member, respectively.

16. The overhead passenger comfort module according to claim 10, wherein each of the module segments further comprises at least one of a speaker system, annunciator light system and information display screen.

17. A vehicle which comprises a pair of passenger seats and the overhead passenger comfort module according to claim 10 positioned over the passenger seats so that passengers in the passenger seats have a respective one of the module segments positioned overhead.

18. The vehicle according to claim 17, wherein the vehicle is a passenger aircraft, a passenger bus or a passenger train car.

19. An aircraft which comprises a pair of facing passenger seats and the overhead passenger comfort module according to claim 10 positioned over the passenger seats so that passengers in the passenger seats have a respective one of the module segments positioned overhead.
